(19) United States
(12) Patent Application Publication
(10) Pub. No.: US 2008/0083222 A1
(43) Pub. Date: Apr. 10, 2008

(54) HYDRAULIC DRIVE SYSTEM

(76) Inventor: Donald Hubert, Cape Coral, FL (US)

Correspondence Address: WOOD AND EISENBERG, PLLC, 6911 RICHMOND HIGHWAY, SUITE 403, Alexandria, VA, 22306, US

(21) Appl. No.: 11/782,637

(22) Filed: Jul. 25, 2007

Related U.S. Application Data
(60) Provisional application No. 60/828,857, filed on Oct. 10, 2006.
(60) Provisional application No. 60/871,773, filed on Dec. 22, 2006.
(60) Provisional application No. 60/882,540, filed on Dec. 28, 2006.

(51) Int. Cl. F01K 23/00

(52) U.S. Cl. 60/698; 180/65.3; 60/719

(57) ABSTRACT

A hydraulic drive system. In a first embodiment the hydraulic drive system comprises a hydraulic circuit, at least one battery, an electric motor and an alternator. The hydraulic circuit includes a hydraulic pump, a hydraulic motor, and a hydraulic fluid reservoir containing hydraulic fluid. In a second embodiment the hydraulic drive system also includes a combustion engine, a fuel tank, and an electrical generator. In another embodiment, the hydraulic drive system includes primary and secondary hydraulic circuits with the secondary hydraulic circuit featuring throttle functionality. In another embodiment the hydraulic drive system provides power generation to a building such as a family home or dwelling. In a further embodiment the hydraulic drive system is adapted to function as a building power generator system.

### CROSS-REFERENCE TO RELATED APPLICATIONS

This application claims the benefit of priority from U.S. Provisional Patent Application Ser. Nos. 60/828,857 (filed Oct. 10, 2006), 60/871,773 (filed Dec. 22, 2006), and 60/882,540 (filed Dec. 28, 2006).

### STATEMENT REGARDING FEDERALLY SPONSORED RESEARCH OR DEVELOPMENT

Not Applicable.

### FIELD OF THE INVENTION

This invention relates to drive systems for use in vehicles, boats and any hardware requiring a drive system. More specifically, the invention is directed to a hydraulic drive system.

### BACKGROUND OF THE INVENTION

Energy fuel prices represent a significant burden on many businesses and household budgets. Prolonged periods of high fuel prices can have a negative impact on the economy of both large and small nations. Vehicle owners frequently feel uncomfortable and nervous when gasoline prices go up and politicians come under pressure to “do something”. Issues such as stability of supply and fear of regional wars breaking out in the Middle East can lead to price instability. Thus, there is a general need to become less dependent on and more efficient in the use of hydrocarbon based energy supplies.

The market has responded with so called hybrid power systems such as that used in the Toyota Prius. While there may be many good reasons to buy and use hybrid vehicles such vehicles are complicated and expensive to make as reflected by the sales prices of such vehicles. Thus, there is a need for more cost-effective and energy-efficient drive systems.

A review of the prior art follows.

U.S. Patent Publication No. 20040244370, published Dec. 9, 2004 to Fukuchi, describes a hydraulic drive device, comprising a hydraulic motor, a rotating body connected to the drive shaft of the hydraulic motor, functioning, by itself as a flywheel, and having an internal gear formed on the output side thereof, a rotation transmitting device having a gear mechanism for transmitting the rotating force of the rotating body to an output shaft gear by allowing counter gears to mesh with the internal gear and the outer shaft gear to mesh with the counter gears, and an output shaft connected to the output shaft gear. Whereby, since a variation in rotating speed of the hydraulic motor can be absorbed by the rotation-transmitting device, the hydraulic motor can be used directly as the drive source of a vehicle such as a car and a truck.

U.S. Patent Publication No. 20050178115, published Aug. 18, 2005 to Hughey, describes a fluid drive system that can be used to drive a vehicle. The '827 fluid drive system is described as having energy regeneration and storage capabilities and includes an electrical energy supply source mounted on the vehicle, at least one electrical motor electrically connected to the electrical supply source, and a hydraulic pump driven that may be of the variable displacement type by the electrical motor. The fluid drive system may also include a low pressure hydraulic fluid supply tank supplying fluid to the hydraulic pump, at least one pneumatically charged accumulator tank for storing pressurized hydraulic fluid, a combination hydraulic motor and pump that may also be of the variable displacement type being alternately driven by the hydraulic pump and the pneumatically charged accumulator tank. The electrical regeneration system may be powered by hydraulic fluid from the combination electrical motor and pump.

U.S. Pat. No. 6,054,838, issued Apr. 25, 2000 to Tsatsis, describes a method and apparatus for electrical storage and pressure charging, by compressed fluid through a venturi, the electrical storage, where the electrical storage can take the form of a battery for operating a motor vehicle and electrical charges are produced by a generator operated by a turbine connected to a pressure storage tank operated when the storage charge falls below a prescribed level; in the method, stored compressed fluid operates a generator for charging the electrical storage.

U.S. Pat. No. 6,748,737, issued Jun. 15, 2004 to Lafferty, describes a hydraulic circuit system and method for storing and converting hydraulic or mechanical energy to electricity wherein the hydraulic circuit system comprises: a power source for generating energy to produce electricity, a hydraulic power unit operably associated with the power source, one or more hydropneumatic accumulators operably associated with the hydraulic power unit, a hydraulic motor operably associated with the accumulators, a flywheel assembly operably associated with the hydraulic motor, a hydrostatic drive unit operably associated with the flywheel assembly, and a generator assembly operably associated with the hydrostatic drive unit wherein the generator assembly is further associated with the hydraulic power unit.

### SUMMARY OF THE INVENTION

A hydraulic drive system. In a first embodiment the hydraulic drive system comprise a hydraulic circuit, a battery, an electric motor and an alternator. The hydraulic circuit includes a hydraulic pump, a hydraulic motor, and a hydraulic fluid reservoir containing hydraulic fluid. In a second embodiment the hydraulic drive system also includes a combustion engine, a fuel tank, and an electrical generator. In another embodiment, the hydraulic drive system includes primary and secondary hydraulic circuits with the secondary hydraulic circuit featuring throttle functionality. In yet another embodiment, the hydraulic drive system provides power generation to a building such as a family home or dwelling.

### BRIEF DESCRIPTION OF THE DRAWINGS

FIG. 1A shows a block diagram of a hydraulic drive system according to the first embodiment of the present invention.

FIG. 1B shows a hydraulic circuit according to the present invention.

FIG. 1C shows a block diagram of a hydraulic drive system according to the present invention.

FIG. 2 shows a block diagram of a hydraulic drive system according to the second embodiment of the present invention.

FIG. 3 shows a top schematic view of a non-limiting implementation of the hydraulic drive system according to the present invention.

FIGS. 4A and 4B show a non-limiting implementation of the hydraulic drive system according to the present invention.

FIG. 5 shows a non-limiting implementation of a hydraulic drive system according to the present invention.

FIG. 6 shows TABLE 1.

FIG. 7 shows another embodiment of the hydraulic drive system comprising primary and secondary hydraulic circuits according to the present invention.

FIG. 8 shows a variation the hydraulic drive system shown in FIG. 7.

FIG. 9 shows a still further embodiment of the hydraulic drive system according to the present invention.

### DETAILED DESCRIPTION OF THE INVENTION

This invention is directed to drive systems for use in vehicles, boats and any hardware requiring a drive system. More specifically, the invention is directed to a hydraulic drive system. The hydraulic drive system of the invention is denoted generally by the numeric label “100”.

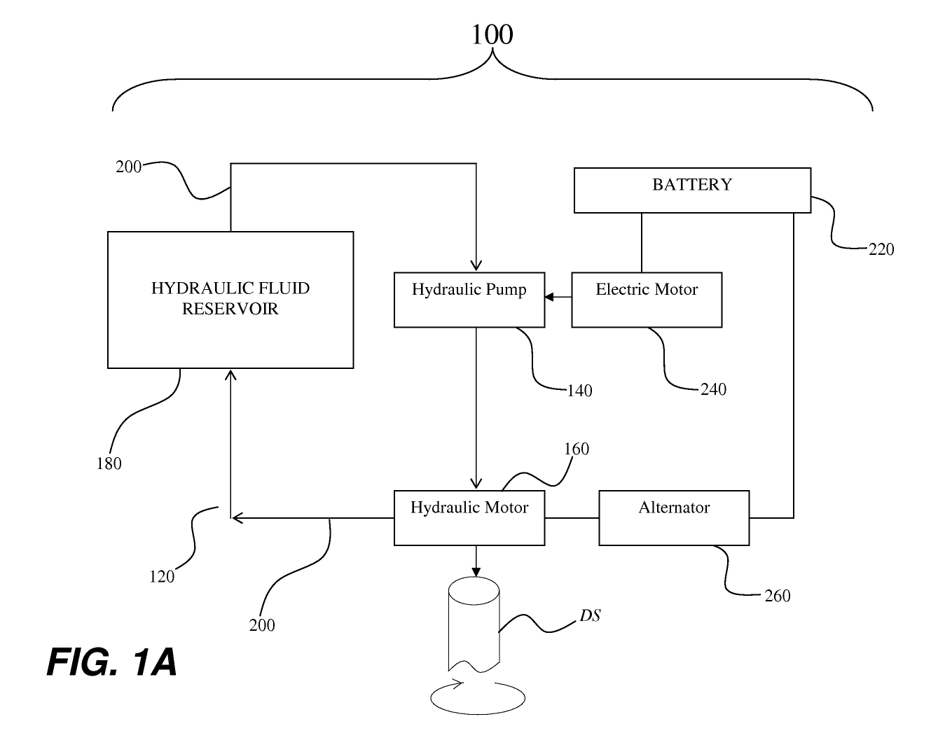

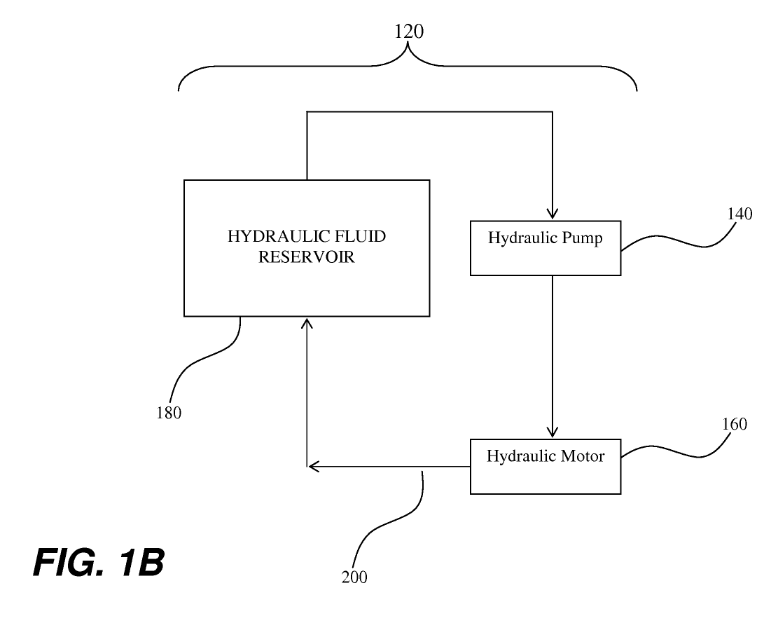

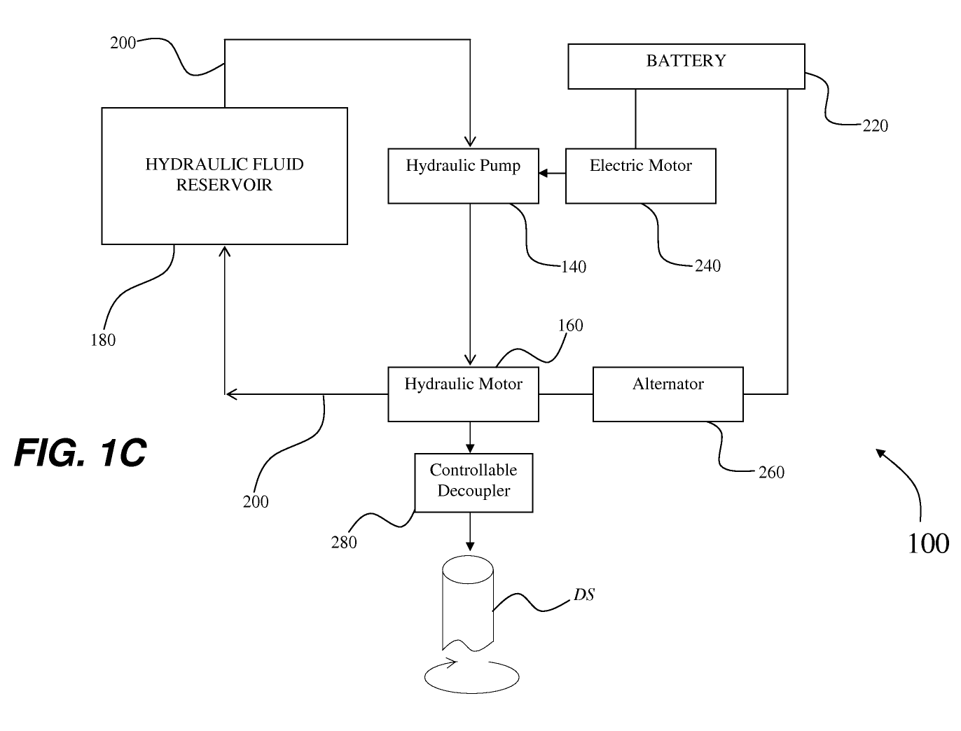

FIG. 1A shows a block diagram of the basic layout of the hydraulic drive system 100 according to the first embodiment of the present invention. The hydraulic drive system 100 comprises: a hydraulic circuit 120 (shown separately in FIG. 1B), at least one battery 220, an electric motor 240 and an alternator 260; the at least one battery 220 can be any suitable battery such as, but not limited to, a rechargeable battery. The hydraulic circuit 120 includes a hydraulic pump 140, a hydraulic motor 160, and a hydraulic fluid reservoir 180 containing hydraulic fluid. The at least one battery 220 could be a single battery or comprise a plurality of batteries, e.g., rechargeable batteries arranged in series. It should be understood that the preferred battery type is a rechargeable battery.

Any regular hydraulic fluid can be used in the hydraulic drive system 100. Cooking oil used in the food industry can function as a suitable hydraulic fluid in the hydraulic drive system 100. For example, biodegradable hydraulic fluids based upon rapeseed (Canola) vegetable oil or peanut cooking oil. BioSOY hydraulic fluid, a soybean-based hydraulic fluid, can also be used. On information and belief BioSOY is supplied Industrial and Transportation Equipment Company (ITEC), which is part of AGRI Industries.

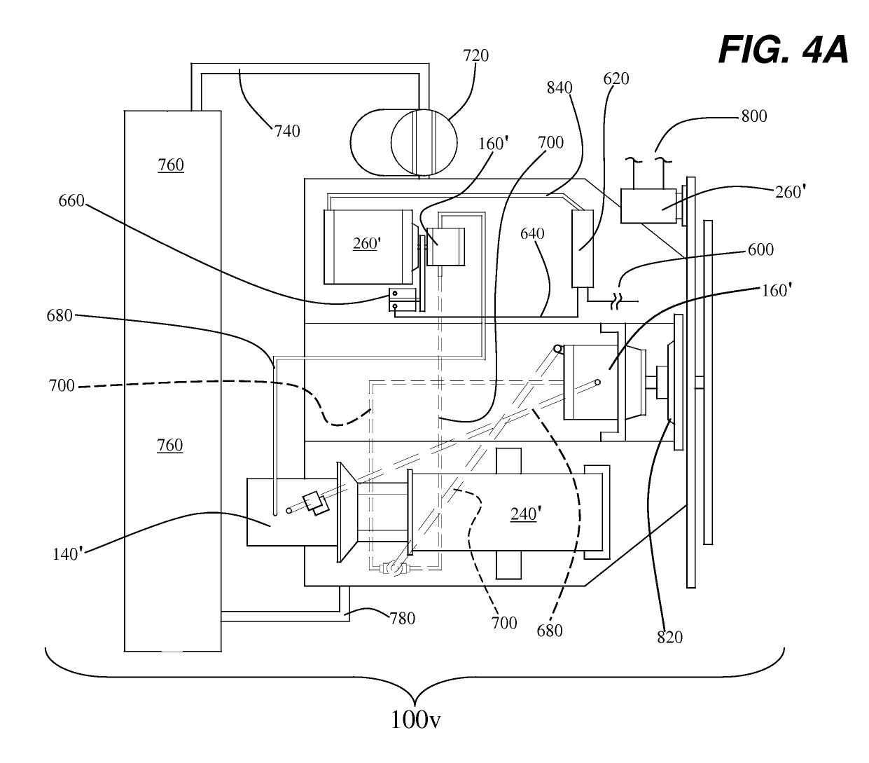

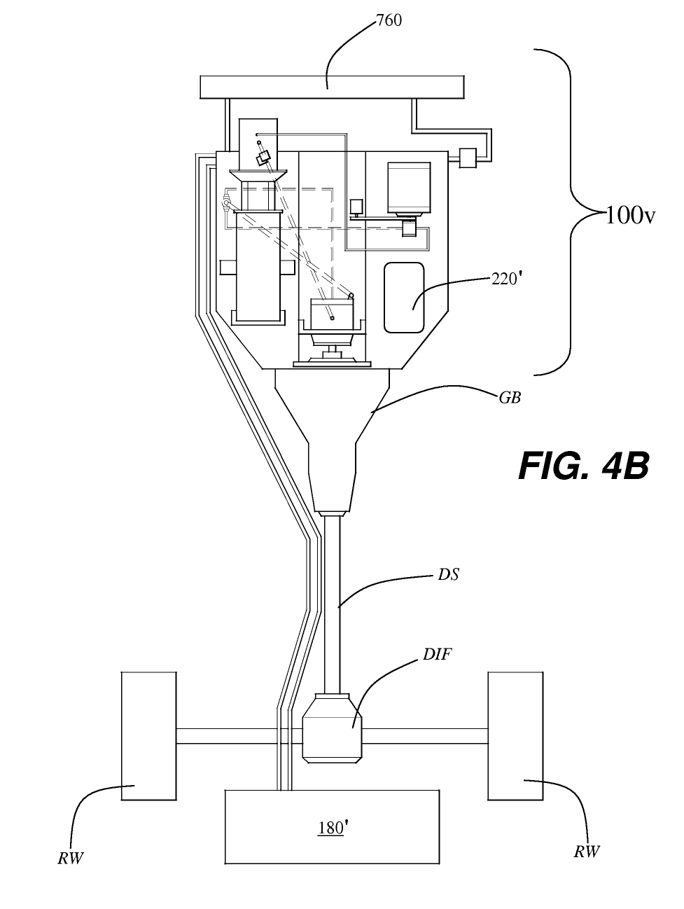

Referring to FIGS. 1A and 1B, hydraulic piping 200 operably connects the hydraulic pump 140, hydraulic motor 160 and the hydraulic fluid reservoir 180. The hydraulic fluid reservoir 180 contains hydraulic fluid. The alternator 260 generates electrical current, which is directed to at least one battery 220 (such as at least one rechargeable battery) and optionally to the electric motor 240. It should be understood that the invention is not limited to employing, for example, just one hydraulic motor 240. Depending on the power output required from the hydraulic drive system 100 more than one type of part can be used in the present invention as shown in FIG. 4A and accompanying description.

Still referring to FIGS. 1A and 1B, the electric motor 240 is operably connected to the hydraulic pump 140 such that the electric motor 240 drives the hydraulic pump 140. The hydraulic motor 160 is operably connected to the alternator 260 such that the hydraulic motor 160 drives the alternator 260. The at least one battery 220 is operably connected to the alternator 260 and the electric motor 240. During normal operation the hydraulic motor 160 is operably connected to a drive shaft DS. The shaft DS could be operably coupled (e.g., via a vehicle's differential), for example, to a vehicle's drive wheels (e.g., via a differential to the front or rear wheels of a vehicle), one or more boat propellers, the rear wheel of a motor cycle, the rear wheels of a three wheel motorcycle such as a trike, or the drive wheels in construction equipment such as an articulated loader.

The hydraulic drive system 100 is particularly useful to use in a working environment where combustion waste gases, including carbon monoxide, can't be tolerated. For example, in tunnel construction where, for example, traditional combustion engine powered trucks would otherwise generate dangerous levels of carbon monoxide (“CO”) leading to serious health and safety concerns. It is thought that CO poisoning caused many deaths in the Hoover Dam construction project where, for example, combustion engine powered trucks were used to haul tunnel debris.

Referring to FIG. 1C, an optional controllable decoupler 280 can be used to control the amount of torque delivered by the hydraulic motor 160 to the drive shaft DS. When less torque is required to rotate the drive shaft DS more power is available to drive the alternator 260. The controllable decoupler 280 is any suitable device for engaging and disengaging a shaft DS and the hydraulic drive system 100; a non-limiting example of a controllable decoupler is a clutch mechanism.

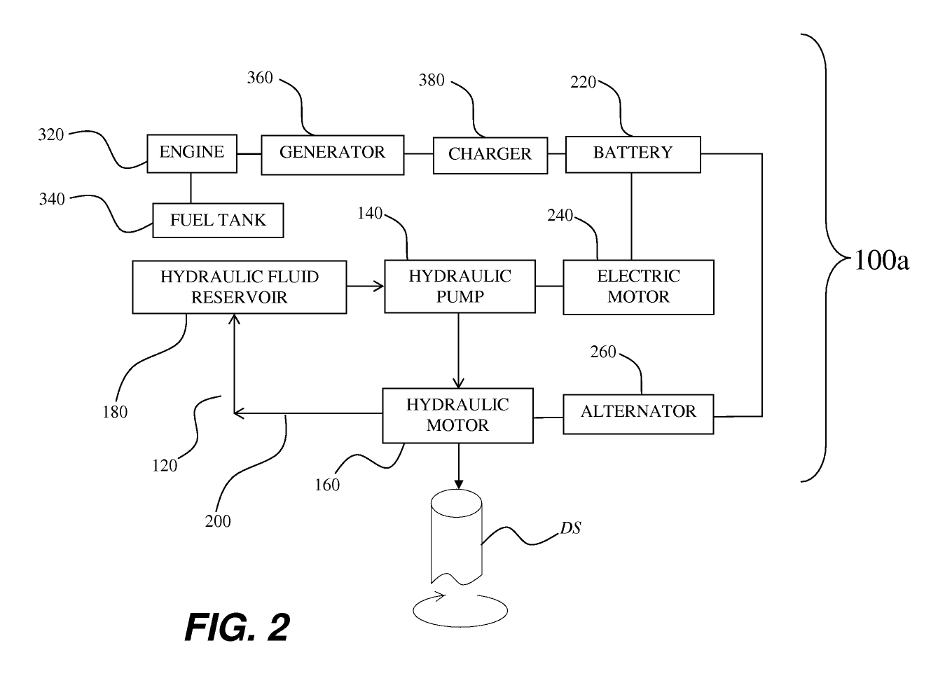

FIG. 2 shows a second embodiment of the hydraulic drive system 100 (actually represented in FIG. 2 by the alpha-numeric label “100a”) of the present invention in which the hydraulic drive system 100 further comprises a combustion engine 320, a fuel tank 340, and an electrical generator 360. The combustion engine 320 is used to run the electrical generator 360, which in turn is operably connected to at least one battery 220, such as at least one rechargeable battery. In this embodiment, the at least one battery 220 receives a charge from generator 360 and/or from alternator 260. The combustion engine 320 receives fuel from fuel tank 340. Any suitable fuel can be stored in fuel tank 340 such as, but not limited to at least one fuel selected from the group consisting of: gasoline, diesel, liquid petroleum gas, methane, and hydrogen. A battery charger circuit 380 can be employed between the generator 360 and the at least one battery 220. It should be understood that the charger circuit 380 could be integrated into the at least one battery 220 or generator 360.

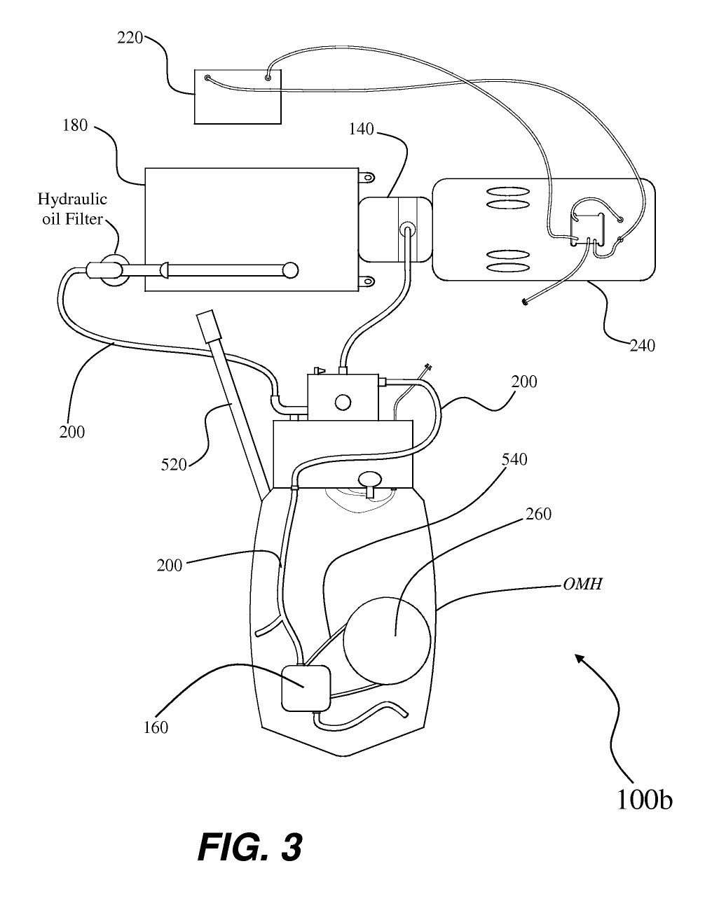

FIG. 3 is a top schematic view of a non-limiting implementation of the hydraulic drive system 100 (represented by alpha-numeric label “10b”) for powering a boat of the type otherwise powered by a traditional outboard motor. The term “outboard motor” refers to a detachable engine mounted on the outboard brackets (not shown) or the stern of a boat (not shown). The motor 160 and alternator 260 are shown housed inside the outboard motor housing OMH. However, it will be understood by a person of ordinary skill in the art that all or some parts of the hydraulic drive system of the present invention could be fitted inside the outboard motor housing OMH. The alternator 260 is operably coupled to the hydraulic motor 160 via power belt 540.

Still referring to FIG. 3, a bar handle 520 is used to steer the outboard hydraulic drive unit 10b. The bar handle 520 can be fitted with a range of devices such as a control element for controlling the controllable decoupler 280 (shown in FIG. 1C) such that for a given power output from the hydraulic motor the amount of torque delivered to the propeller driveshaft (not shown in FIG. 3, but represented in a general way by drive shaft DS in FIGS. 1A and 1C) can be controlled at the expense or gain of the torque delivered to the alternator 260 via power belt 540.

Referring to FIGS. 4A and 4B, which show a non-limiting implementation of the hydraulic drive system 100 (actually represented by the alpha-numeric label “100v”) for powering a vehicle such as, but not limited to, a car, an SUV, a pick-up truck such as, but not limited to, a Ford F-series F150 pick-up truck.

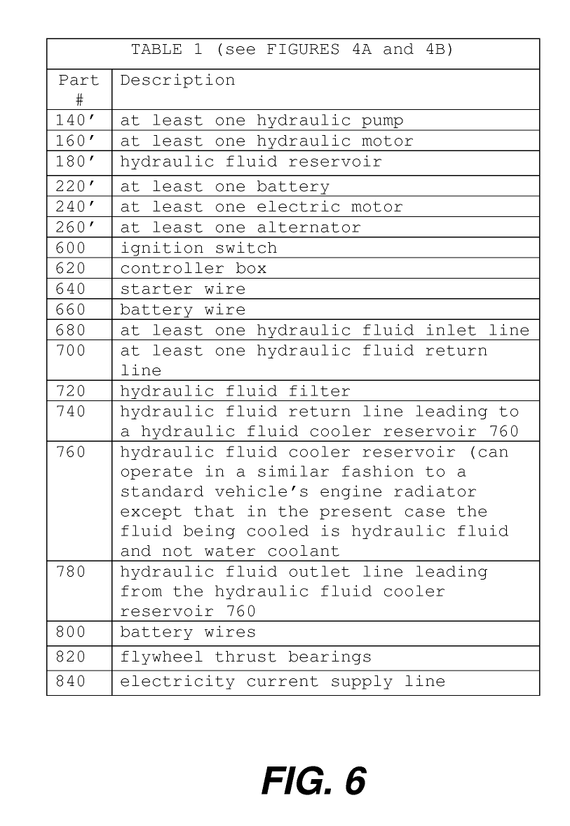

Still referring to FIGS. 4A and 4B, the hydraulic drive system 100v comprises: at least one hydraulic pump 140′, at least one hydraulic motor 160′, at least one hydraulic fluid reservoir 180′, at least one battery 220′, at least one electric motor 240′, and at least one alternator 260′. At least one hydraulic pump 140′is operably connected to drive at least one hydraulic motor 160′. At least one electric motor 240′ is operably connected to drive at least one hydraulic pump 140′. At least one hydraulic motor 160′ is operably connected to drive at least one alternator 260′. At least one battery 220′ is operably connected to at least one alternator 260′. At least one battery 220′ is operably connected to at least one electric motor 240′. In more detail, the hydraulic drive system 100v comprises the elements shown in TABLE 1; TABLE 1 is shown in FIG. 6. The at least one battery 240′ can comprise one or more rechargeable batteries.

Referring to FIGS. 4A and 4B with emphasis on FIG. 4B, the hydraulic drive system 100v can be coupled to a vehicle's transmission system such as a vehicle's gearbox GB and thus be operably connected to a vehicle's drive wheels (represented by rear-drive wheels RW) via standard hardware such as a vehicle's driveshaft DS and a mechanical differential DIF.

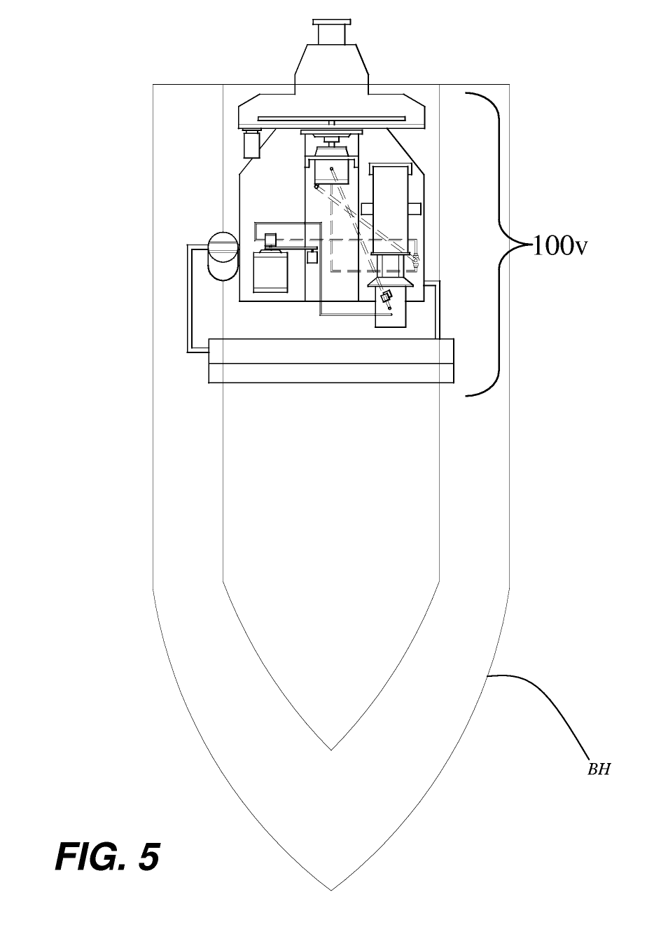

The hydraulic drive system 100v can be fitted to power any type of device requiring torque to operate, such as a boat's propeller. For example, hydraulic drive system 100v can be fitted inside the stern of a boat hull BH as shown in FIG. 5, farm equipment (such as, but not limited to, a tractor or combine-harvester), a pick-up truck, an articulated truck, and construction equipment (such as, but not limited to, an articulated loader, backhoe, bulldozer or crane).

Electric current generated by the at least one alternator is used to drive the electric motor and/or recharge the battery. The electric motor is initially started up using electrical power from the battery and thereafter is powered by a combination of electricity delivered from the alternator and the battery. The alternator may be a double diode alternator rigged to provide electrical output to two circuits, the electric motor and/or the battery. Any suitable supplier of alternators can be used such as Penntex Industries, Inc. Suitable alternators include the Penntex PX-421SMD.

Over a period of time the battery will run down; thus, the present invention is not 100% efficient and so does not represent a perpetual motion machine, but instead represents an alternative drive system to run vehicles, boats, tractors, etc.

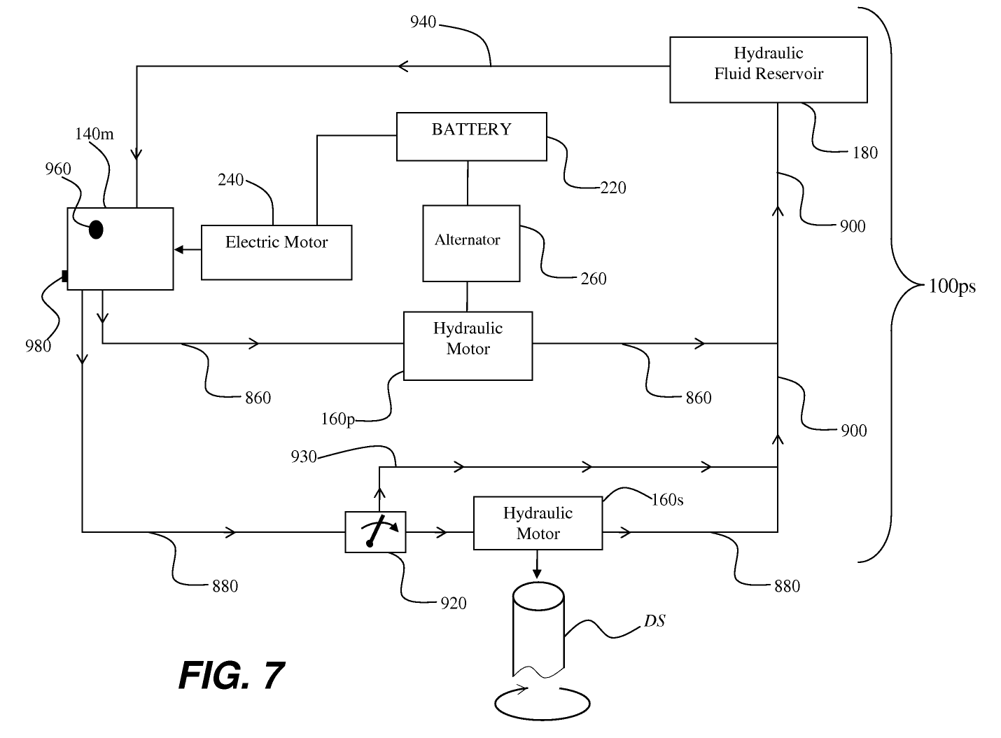

FIG. 7 shows another embodiment according to the present invention in which the hydraulic drive system 100 (represented by the alpha-numeric label “100ps”) comprises primary and secondary hydraulic circuits 860 and 880, respectively. The primary circuit 860 drives a primary hydraulic motor 160p operably coupled to alternator 260. The primary and secondary hydraulic circuits 860 and 880 are located between a main-hydraulic pump 140m and a hydraulic-fluid-return-line 900. During normal operation the hydraulic-fluid-return-line 900 returns hydraulic fluid from the primary and secondary hydraulic circuits 860 and 880 to the hydraulic fluid reservoir 180.

The purpose of the primary circuit 860 is to provide steady torque delivery to the alternator 260 via hydraulic motor 160p.

The purpose of the secondary circuit 880 is to provide throttle control. A secondary circuit fluid control valve 920 provides throttle control by allowing a user to control the amount of hydraulic fluid delivered to the hydraulic motor 160s thereby controlling the amount of torque generated by the hydraulic motor 160s.

Referring to FIG. 7 in more detail, the hydraulic drive system 100ps comprises: hydraulic fluid reservoir 180, at least one battery 220 (such as, but not limited to, one or more rechargeable batteries); electric motor 240, which during normal operation receives power from the at least one battery 220; a main-hydraulic pump 140m, which during normal operation is driven by the electric motor 240; a primary hydraulic circuit 860, the primary hydraulic circuit 860 comprises a primary-hydraulic motor 160p, which is operably connected to alternator 260, the alternator 260 is operably connected to the at least one battery 220; a secondary hydraulic circuit 880, the secondary hydraulic circuit 880 comprises a secondary hydraulic fluid control valve 920, a secondary-hydraulic motor 160s, and a bypass hydraulic line 930; and a hydraulic-fluid-return-line 900. The secondary circuit fluid control valve 920 can be connected, for example, to bar handle 520 (not shown in FIG. 7, but shown in FIG. 3); alternatively, the secondary circuit fluid control valve 920 can be operated manually without using bar handle 520.

Still referring to FIG. 7, during normal operation the secondary hydraulic motor 160s is coupled to a drive shaft DS. The main-hydraulic pump 140m receives hydraulic fluid via an input-hydraulic-fluid-line 940 from the hydraulic fluid tank 180. The main-hydraulic pump 140m may comprise first and second output adjustment valves 960 and 980. The main-hydraulic pump 140m pumps hydraulic fluid into the primary and secondary hydraulic circuits 860 and 880. The first and second output adjustment valves 960 and 980 respectively control the rate of hydraulic fluid flow into the primary and secondary circuits 860 and 880.

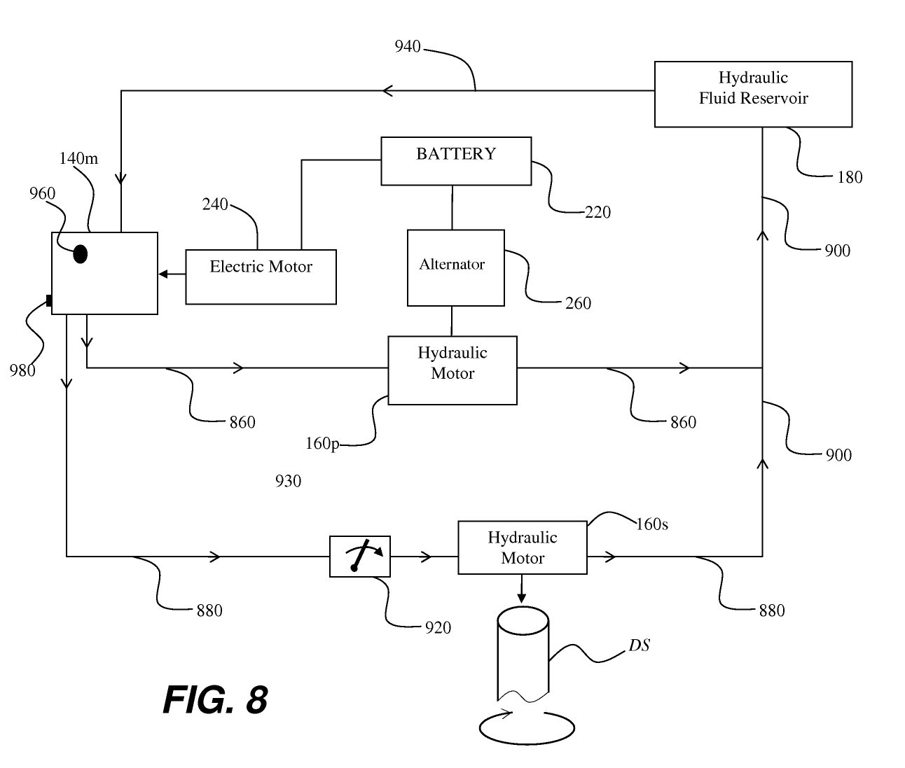

FIG. 8 is similar to the hydraulic drive system 100ps of FIG. 7, but lacks a bypass hydraulic line 930.

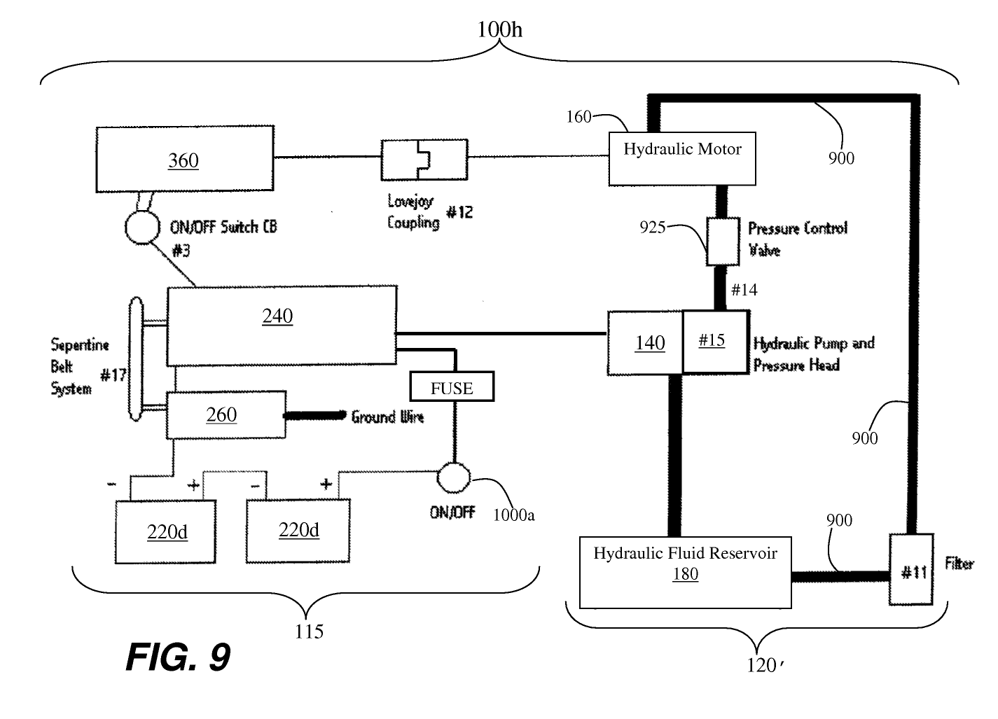

FIG. 9 shows another embodiment according to the present invention in which the hydraulic drive system is used as a building power generator system, e.g., such as a home power generator system; the building power generator system is represented in FIG. 9 by the alpha-numeric label “100h”.

The building power generator system 100h comprises a power circuit 115 and a hydraulic circuit 120′. The hydraulic circuit 120′ comprises hydraulic pump 140, hydraulic motor 160, and a fluid reservoir 180. The hydraulic pump 140 is coupled to a pressure head #15. A pressure control valve 925 and a hydraulic fluid filter #11 are optional parts of the hydraulic circuit 120′.

The power circuit 115 comprises a battery setup 220d, an alternator 260, electric motor 240 and an electricity generator 360. The electricity generator 360 is operatively coupled to the hydraulic motor 160, wherein the hydraulic motor 160 is selectively used to drive the generator 360. The electric motor is operatively coupled to the hydraulic pump 140.

Still referring to FIG. 9, an ON/OFF switch 1000a (such as, but not limited to, a keyed ON/OFF single pole power switch) when turned to the “ON” position, allows a dual battery setup 220d to send electric power to an electric motor 240 (which can further comprise a solenoid (not shown)); the electric motor 240 primes a hydraulic pump 140 with fluid (such as, but not limited to, peanut cooking oil) from reservoir tank 180. Once the hydraulic pump has received power from the battery setup 220d via the electric motor 240 and is primed with hydraulic fluid, the hydraulic pump 140 pushes the fluid from a pressure head #15 through a hydraulic pressure line #14 to hydraulic motor 160. The hydraulic pressure line #14 includes fluid pressure control valve 925. The hydraulic motor 160 is coupled to the shaft of an electric generator 360 (such as, but not limited to, an electricity generator rated at about 50 KW) via a lovejoy coupling system #12. In one embodiment, the electric generator 360 comprises one or more 120V plug outlets such as, but not limited to, two 120V plug outlets (not shown).

Lovejoy couplings are available from, for example, Lovejoy Incorporated, located at: 2655 Wisconsin Avenue, Downers Grove, Ill. 60515, Phone: 630-852-0500, Fax: 630-852-2120.

Still referring to FIG. 9, hydraulic fluid exiting the hydraulic motor 160 is returned to the hydraulic fluid reservoir 180 via hydraulic return line 900, which includes filter #11 to complete the hydraulic fluid flow circuit. The filter #11 can be any suitable hydraulic fluid filter such as, but not limited to, a ten-micron filter.

Still referring to FIG. 9, once the hydraulic motor 160 reaches a desired RPM (which is regulated by control valve 925, and is spinning the shaft of the generator 360 (such as, but not limited to, a 50 KW generator), a second single pole ON/OFF switch (#3) is turned to the “ON” position to allow the generator to start producing electric current.

Once the generator 360 is turned ON, it supplies electric current to power, for example, a family home. During low load periods power output from the generator 360 can be diverted via switch #3 to the motor 240 to drive alternator 260. The alternator 260 attached to the electric motor 240 via a serpentine belt system #17 recharges the battery setup 220d. Thus, if the building requires less electrical power, the residue energy in the circuit 120′ can be utilized to charge the battery setup 220d.

Over time energy can be added to the system, e.g., by providing a fresh set of charged batteries or electric current from the mains to maintain charge in the batteries. For example, the batteries 220d could be charged from the mains during a non-peak period. The battery setup 220d can be, for example, at least one rechargeable battery or a dual battery setup comprising two rechargeable batteries in series. However, it will be understood by a person of ordinary skill in the art that the battery setup 220d can comprise any suitable number of rechargeable batteries so long as the voltage and current provided by the batteries is sufficient to drive electric motor 240.

It is to be understood that the present invention is not limited to the specific embodiments described above, but encompasses any and all embodiments within the scope of the following claims.

I claim:

1. A hydraulic drive system, comprising:
a hydraulic circuit, comprising:
a hydraulic pump,
a hydraulic motor, and
a hydraulic fluid reservoir containing hydraulic fluid,
wherein said hydraulic pump is operably connected to drive said hydraulic motor;
a battery;
an electric motor; and
an alternator,
wherein said electric motor is operably connected to said hydraulic pump such that said electric motor drives said hydraulic pump,
wherein said hydraulic motor is operably connected to said alternator such that said hydraulic motor drives said alternator,
wherein said battery is operably connected to said alternator, and further wherein said battery is operably connected to said electric motor.

2. The hydraulic drive system according to claim 1 further comprising a combustion engine, a fuel tank, and an electricity generator, wherein said combustion engine drives said electricity generator, and said electricity generator is operably coupled to said battery for charging said battery.

3. The hydraulic drive system according to claim 1, wherein during normal operation said hydraulic motor is operably connected to a drive shaft.

4. The hydraulic drive system according to claim 1, wherein during normal operation said hydraulic motor is operably connected to a drive shaft, wherein said drive shaft is at least one drive shaft selected from a group consisting of: a drive shaft operably connected to a vehicle's drive wheels, a drive shaft operably connected to a boat propeller, a drive shaft operably connected to a rear wheel of a two-wheeled motorcycle, a drive shaft connected to a tractor's rear wheels, a drive shaft connected to a trike's rear wheels, and a drive shaft connected to a generator (360).

5. The hydraulic drive system according to claim 1, wherein during normal operation said hydraulic motor is operably connected to a drive shaft, and said drive system further comprises a controllable decoupler, wherein said controllable decoupler is used to control the amount of torque delivered by the hydraulic motor to the drive shaft such that as less torque is delivered to the drive shaft more power is available to drive said alternator.

6. A hydraulic drive system, comprising:
at least one hydraulic pump;
at least one hydraulic motor;
at least one hydraulic fluid reservoir containing hydraulic fluid, wherein said at least one hydraulic pump is operably connected to drive at least one hydraulic motor;
at least one battery;
at least one electric motor; and
at least one alternator,
wherein at least one electric motor is operably connected to drive at least one hydraulic pump,
wherein said at least one hydraulic motor is operably connected to drive at least one alternator,
wherein said at least one battery is operably connected to at least one alternator, and further wherein said at least one battery is operably connected to at least one electric motor.

7. The hydraulic drive system according to claim 6 further comprising a combustion engine, a fuel tank, and an electricity generator, wherein said combustion engine drives said electricity generator, and said electricity generator is operably coupled to said at least one battery for charging said at least one battery.

8. A hydraulic drive system, comprising:
a hydraulic fluid tank;
a battery;
an electric motor, which during normal operation receives power from said battery;
a main-hydraulic pump, which during normal operation is driven by said electric motor;
a primary hydraulic circuit, said primary hydraulic circuit comprises a primary-hydraulic motor operably connected to an alternator, said alternator is operably connected to said battery;
a secondary hydraulic circuit, said secondary hydraulic circuit comprises a secondary hydraulic fluid control valve, a secondary-hydraulic motor, and a bypass hydraulic line; and
a hydraulic-fluid-return-line,
wherein during normal operation said secondary hydraulic motor is coupled to a drive shaft,
wherein said main-hydraulic pump receives hydraulic fluid via an input-hydraulic-fluid-line from said hydraulic fluid tank, said main-hydraulic pump is operatively connected to a first output control valve and a second output control valve, said main-hydraulic pump pumps hydraulic fluid into said primary and secondary hydraulic circuits, wherein said first and second output control valves respectively control the rate of hydraulic fluid flow into said primary and secondary circuits,
wherein said primary hydraulic circuit and said secondary hydraulic circuit are located between said main-hydraulic pump and said hydraulic-fluid-return-line, wherein during normal operation said hydraulic-fluid-return-line returns hydraulic fluid from said primary and secondary hydraulic circuits to said hydraulic fluid tank, and
wherein said secondary hydraulic control valve functions as a throttle control by controlling the flow rate of hydraulic fluid to said secondary-hydraulic motor such that when the flow rate of hydraulic fluid to said secondary-hydraulic motor is restricted by said secondary hydraulic control valve said bypass hydraulic line acts as a bypass to shunt hydraulic fluid past said secondary-hydraulic motor to said hydraulic-fluid-return-line.

9. A hydraulic drive system adapted to function as a building power generator system, comprising:
a hydraulic circuit, said hydraulic circuit comprises a hydraulic motor, a hydraulic pump, and a hydraulic fluid reservoir; and
a power circuit, said power circuit comprises a battery setup, an alternator, an electric motor and an electricity generator,
wherein said electricity generator is operatively coupled to said hydraulic motor,
wherein said hydraulic motor is selectively used to drive said electricity generator,
wherein said electric motor is operatively coupled to said hydraulic pump, and
wherein said electric motor is selectively used to drive said hydraulic pump.

10. The hydraulic drive system adapted to function as a building power generator system according to claim 9, wherein said hydraulic pump is coupled to a pressure head, and wherein said hydraulic circuit further comprises a pressure control valve and a hydraulic fluid filter.

11. The hydraulic drive system adapted to function as a building power generator system according to claim 9, wherein said electricity generator is rated at about 50 kW.
